(19) United States
(12) Patent Application Publication
(10) Pub. No.: US 2026/0217333 A1
(43) Pub. Date: Jul. 30, 2026

(54) Bottom Bracket Gearing System with an Arrangement for Actuating a Brake Shift Element

(71) Applicant: ZF Friedrichshafen AG, Friedrichshafen (DE)

(72) Inventors: Peter Ziemer, Bad Woerishofen (DE); Hagen Doepfert, Lindau (DE)

(21) Appl. No.: 19/148,899

(22) PCT Filed: Jan. 12, 2024
(86) PCT No.: PCT/EP2024/050676

§ 371 Date: Jul. 17, 2025

(30) Foreign Application Priority Data
Jan. 17, 2023 (DE) 10 2023 200 310.4

(51) Int. Cl. B62M 11/14; B62M 11/18

(52) U.S. Cl. CPC B62M 11/145; B62M 11/18

(57) ABSTRACT

A bottom bracket gearbox for a bicycle, the bottom bracket gearbox having a planetary gear set design, the bottom bracket gearbox including at least one brake shift element, at least one brake pawl actuatable for blocking and releasing an associated gearbox component for shifting a gear step, and an arrangement for actuating the at least one brake pawl. The arrangement includes at least one cam element, each of the at least one cam element being operatively connected to a respective one of the at least one brake pawl and being separately activatable.

### CROSS-REFERENCE TO RELATED APPLICATION

The present application is related and has right of priority to German Patent Application No. 10 2023 200 310.4 filed on Jan. 17, 2023 and is a nationalization of PCT/EP2024/050676 filed in the European Patent Office on Jan. 12, 2024, both of which are incorporated by reference in their entirety for all purposes.

### FIELD OF THE INVENTION

The present invention relates generally to a bottom bracket gearbox in a planetary gear set design for a bicycle, the bottom bracket gearbox having an arrangement for actuating a brake shift element. The invention further relates generally to a bicycle having the bottom bracket gearbox.

### BACKGROUND

A bottom bracket gearbox having an arrangement for actuating a shift element is known, for example, from document DE 10 2019 220 044 A1. The arrangement includes a rotatably arranged gear selector drum, the gear selector drum having multiple curved paths, which are axially adjacent to one another, for sequentially actuating multiple brake pawls of the brake shift elements, such that gears can only be shifted sequentially with the bottom bracket gearbox. Consequently, the gear shifts from the engaged gear to the target gear take place sequentially in an established order, i.e., gears cannot be skipped over, as a result of which the shifting duration increases.

### SUMMARY OF THE INVENTION

A bottom bracket gearbox and a vehicle having the bottom bracket gearbox are provided, which also enable, in addition to sequential gear shifts, direct gear shifts to skip over gear steps.

A bottom bracket gearbox in a planetary gear set design for a bicycle is described, which bottom bracket gearbox has an arrangement for actuating a brake pawl of a brake shift element for blocking and releasing a gearbox component for shifting a gear step. In order to also enable, in addition to sequential gear shifts, direct gear shifts to skip over gear steps, each brake pawl is operatively connected to a respective, separately activatable, rotatable cam element.

The bicycle is preferably a (high-speed) pedelec, an e-bike, a velomobile, a cargo bike, or the like. The bicycle preferably has an electrical (auxiliary) propulsion means.

In this way, a decentral actuation, or actuation of brake shift elements of the bottom bracket gearbox, by the separately activatable cam elements is enabled such that not only is a sequential gear shift of adjacently arranged gear steps made possible, but direct gear shifts into any gear step are also made possible due to the cam elements associated with each brake pawl, so that any desired target gear is directly engageable in any gear shift sequence regardless of the current engaged gear.

Preferably, the brake pawl is a spring-loaded rocker, a first rocker arm being associated with a locking toothing of the gearbox component and a second rocker arm being associated with a curved path provided on the periphery of the separately activatable cam element for actuating the brake pawl. The brake pawl is preferably a normally closed brake pawl. This means that the spring-loaded rocker is pressed with its pawl tip, or with its pawl hook on the first rocker arm, by spring force into the locking toothing of the gearbox component to be blocked, such as, for example, a planet carrier, a sun gear, or a ring gear of the bottom bracket gearbox, in order to block, or rotationally fix, the gearbox component, such that the associated gear is shiftable.

In order to minimize the friction at the contact surface between the brake pawl and the cam element in the bottom bracket gearbox that enables direct gear shifts in any gear shift sequence, a rotatable roller or the like is provided, for example, on the second rocker arm of the brake pawl as a contact surface with the periphery of the cam element.

A swivel axis of each brake pawl and a rotational axis of each cam element are preferably arranged approximately axially parallel to a central axis of rotation of the bottom bracket gearbox. In this way, the required components of the bottom bracket gearbox according to the invention are integrated into the existing bottom bracket shell in order to also enable, in addition to the sequential gear shifting, the direct gear shifting without an additional housing.

In order to activate each cam element in a particularly simple manner, for example, a rotary drive, for example, as an electric servomotor or the like, is associated with each cam element. In order to activate each cam element, it is only necessary that the cam element be rotated in one direction of rotation.

The rotational motion of each rotary drive is transmittable onto the associated cam element, for example, via a high gear ratio reduction gear. A particularly compact and low-cost reduction gear is realized by using multiple planetary gear sets or the like, that are coupled to each other, as the reduction gear.

In order to actuate each brake pawl by the associated cam element, a curved path having a first shorter ramp portion formed with a greater slope for quickly engaging the brake pawl into the locking toothing of the associated gearbox component and having a second longer ramp portion formed with a lesser slope for disengaging the shift pawl with low load is provided along the periphery of each cam element. In this way, the spring-loaded engagement of the brake pawl is released and accelerated due to the steep ramp portion by a short rotational motion of the cam element, while the disengagement of the brake pawl due to the flat, longer ramp portion is enabled by a longer rotational motion of the cam element with the lowest load possible. Consequently, the rotary drive of the cam element has correspondingly small dimensions.

In order to simplify the activation when carrying out the direct gear shifts with the bottom bracket gearbox according to the invention, a position detection sensor is associated with the rotatable cam element. In this way, the position of each cam element is known by the gear shift activation controller at any time.

A bicycle is also described having the above-described bottom bracket gearbox, wherein the above-described advantages and further advantages result.

### BRIEF DESCRIPTION OF THE DRAWINGS

The present invention is explained in greater detail in the following with reference to the drawings, wherein:

FIG. 1 shows a schematic side view of a bottom bracket gearbox, according to the invention, of a bicycle, which has a cam element for actuating a brake pawl of a brake shift element;

FIG. 2 shows a schematic section view of a gearbox section through the bottom bracket gearbox according to the invention;

FIG. 3 shows a schematic side view of the bottom bracket gearbox with multiple cam elements for actuating multiple brake pawls;

FIG. 4 shows a schematic side view of the bottom bracket gearbox with multiple cam elements for actuating multiple brake pawls in an alternative arrangement position;

FIG. 5 shows a gearbox section view through the bottom bracket gearbox according to the invention with multiple cam elements for actuating multiple brake pawls;

FIG. 6 shows an elementary schematic diagram of the bottom bracket gearbox; and

FIG. 7 shows a gear shift matrix of the brake shift elements and of the freewheel clutches of the bottom bracket gearbox according to FIGS. 5 and 6.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

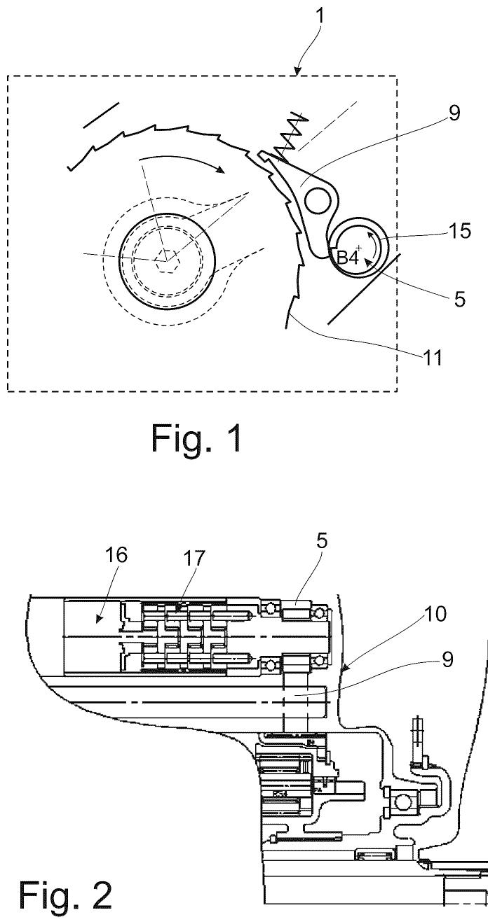

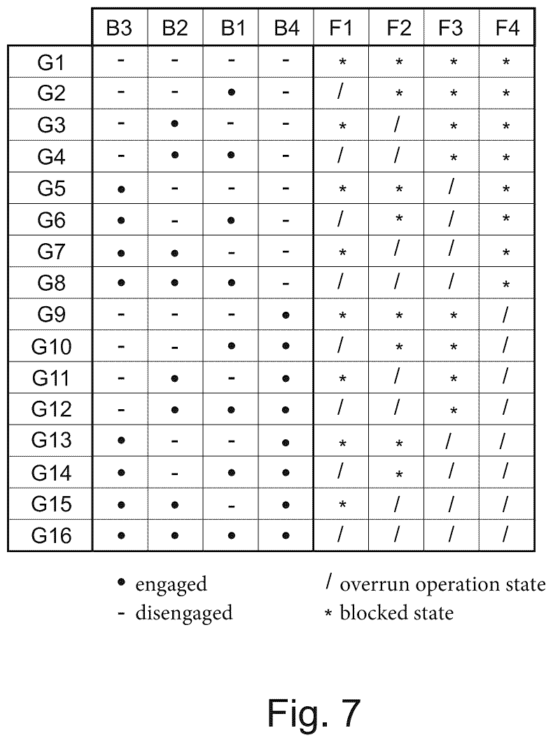

In FIGS. 1-6, various views of a bottom bracket gearbox in a planetary gear set design are shown, by way of example, on a bicycle 1 as a pedelec. The bottom bracket gearbox has one or multiple rotatable cam element(s) 2, 3, 4, 5 as an arrangement for separately actuating one or multiple brake pawl(s) 6, 7, 8, 9 of brake shift elements B1, B2, B3, B4. FIG. 7 shows a gear shift matrix for the brake shift elements B1, B2, B3, B4 and freewheel clutches F1, F2, F3, F4 of the bottom bracket gearbox, which is a 16-speed gearbox merely by way of example. A brake shift element B1, B2, B3, B4 is generally understood to be an actuatable brake that, when engaged, rotationally fixes a gearbox component or connects a gearbox component to a housing 10 of the bottom bracket gearbox.

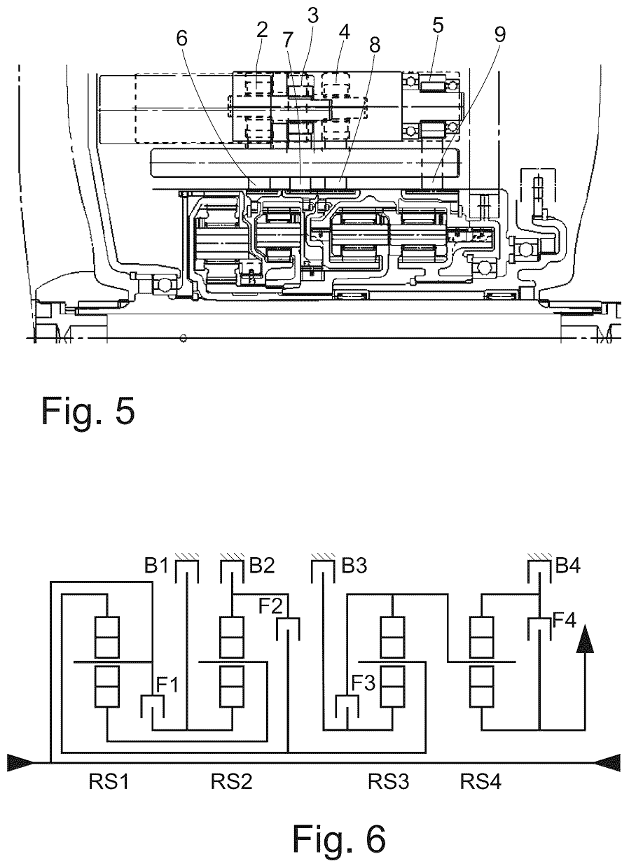

The invention relates, by way of example, to a bottom bracket gearbox in a planetary gear set design with multiple, preferably four, planetary gear sets RS1, RS2, RS3, RS4 for a bicycle 1, the bottom bracket gearbox having the cam elements 2, 3, 4, 5 for actuating at least one of the brake shift elements B1, B2, B3, B4. The bottom bracket gearbox is shown in detail in FIGS. 5 and 6.

The bottom bracket gearbox includes, as an arrangement for actuating the four brake pawls 6, 7, 8, 9 of the four brake elements B1, B2, B3, B4, the four separately activatable cam elements 2, 3, 4, 5 for blocking and releasing a gearbox component for shifting any gear step G1-G16 regardless of the particular engaged gear step or “gear ratio”.

FIG. 1 shows, by way of example, a fourth cam element 5 for actuating a fourth brake pawl 9 of a fourth brake shift element B4. Each brake pawl 6, 7, 8, 9 is a spring-loaded rocker, a first rocker arm being associated with a locking toothing 11 of the particular gearbox component and a second rocker arm being associated with a curved path 12, 13, 14, 15 provided on the periphery of the separately controllable cam element 2, 3, 4, 5. The curved path 12, 13, 14, 15 on each cam element 2, 3, 4, 5 has a first shorter ramp portion formed with a greater slope for quickly engaging the brake pawl, and a second longer ramp portion formed with a lesser slope for disengaging the shift pawl from the locking toothing of the associated gearbox component. The terms “shorter” ramp portion and “longer” ramp portion relate to the rotational angle range of the cam element 2, 3, 4, 5, such that the first ramp portion extends over a smaller rotational angle range and the second ramp portion extends over a greater rotational angle range. Each cam element 2, 3, 4, 5 has a dedicated rotary drive 16 for separate activation, which rotary drive is operatively connected to the particular cam element 2, 3, 4, 5 via a reduction gear 17 consisting of multiple planetary gear sets that are coupled to each other, in order to rotate the cam element 2, 3, 4, 5, for example, in the counterclockwise direction.

In FIG. 1, the brake pawl 9 of the fourth brake shift element B4 is in the disengaged state, since the second rocker arm of the brake pawl 9 is located on the second ramp portion of the curved path 15 of the cam element 5 closely ahead of the first steep ramp portion of the curved path 15. Consequently, the brake pawl 15 is held against the spring force in a position in which the first rocker arm is not in engagement with the locking toothing 11. When the cam element 5 is rotated further by the associated rotary drive 16, the brake pawl 9 is released due to the steep ramp portion and is engageable into the locking toothing 11 due to the spring force.

FIG. 2 shows, by way of example, the rotary drive 16 with the reduction gear 17 on the basis of the fourth cam element 5 for actuating the fourth brake pawl 9 of the fourth brake shift element B4. The reduction gear 17 consists, by way of example, of four planetary gear sets, the rotary drive being coupled to the reduction gear via a sun gear, while the ring gears of the planetary gear sets are rotationally fixed at the housing 10, and the planet carriers of the planetary gear sets are each coupled to the respective sun gear of the adjacent planetary gear set, wherein the planet carrier of the last planetary gear set is connected to the cam element 5 for driving.

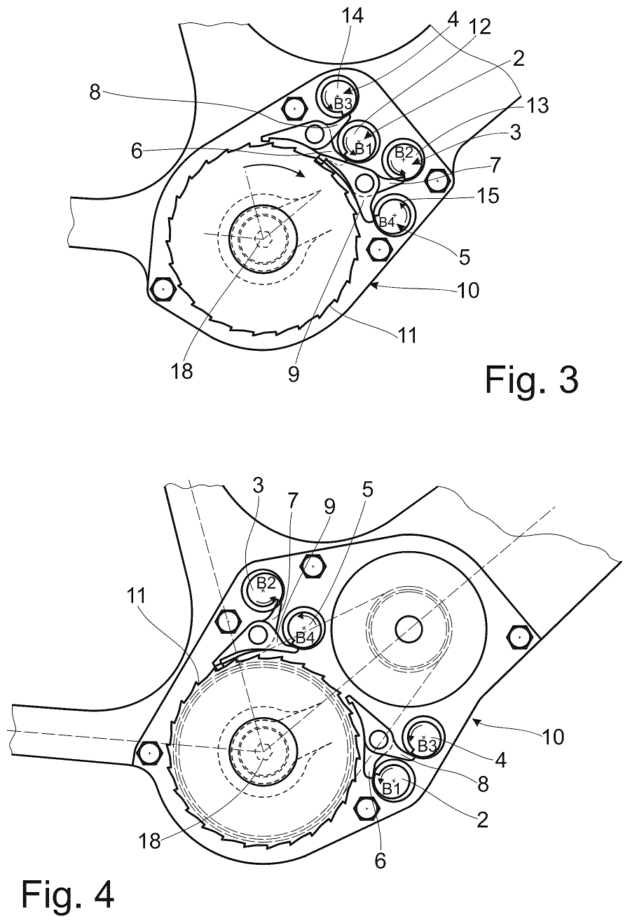

As is apparent, for example, from FIGS. 3-5, the swivel axes of the brake pawls 6, 7, 8, 9 and the rotational axes of the cam elements 2, 3, 4, 5 are arranged approximately axially parallel to a central axis of rotation of the bottom bracket gearbox 18.

FIG. 3 shows an arrangement position of the cam elements 2, 3, 4, 5 and of the brake pawls 6, 7, 8, 9 in a common area of the housing 10. FIG. 4 shows an alternative arrangement position of the cam elements and of the brake pawls in separate areas of the housing on the periphery of the bottom bracket gearbox. Regardless of the arrangement position, the first brake pawl 6 and the third brake pawl 8 are associated with a common bolt having a common swivel axis, while the second brake pawl 7 and the fourth brake pawl 9 are also associated with a common bolt having a common swivel axis.

It is apparent from FIGS. 3-5 that the first separately activatable cam element 2 is associated with the first brake pawl 6 of the first brake shift element B1, the second separately activatable cam element 3 is associated with the second brake pawl 7 of the second brake shift element B2, the third separately activatable cam element 4 is associated with the third brake pawl 8 of the third brake shift element B3, and the fourth separately activatable cam element 5 is associated with the fourth brake pawl 9 of the fourth brake shift element B4.

FIG. 6 shows a schematic diagram of the bottom bracket gearbox with the four planetary gear sets RS1, RS2, RS3, RS4. In order to implement the 16 gear stages G1-G16, four brakes B1, B2, B3, B4 and four freewheel clutches F1, F2, F3, F4 are associated with the planetary gear sets RS1, RS2, RS3, RS4. The gearbox design, which is per se known, is not described further, since it is apparent to a person skilled in the art.

FIG. 7 shows the corresponding gear shift matrix of the bottom bracket gearbox shown in FIGS. 5 and 6. In the shown gear shift matrix according to FIG. 7, a dash “-” for the brake shift elements B1, B2, B3, B4 indicates a disengaged state, i.e., a release of the associated gearbox component, while a dot “.” in the gear shift matrix corresponds to the closed or engaged state of the brake shift elements B1, B2, B3, B4. With respect to the freewheel clutches F1, F2, F3, F4, a slash “/” in the gear shift matrix for implementing the particular gear step G1-G16 indicates the overrun operation state, while an asterisk “*” in the gear shift matrix for implementing the corresponding gear step G1-G16 indicates the blocked state.

A direct, non-sequential gear shift in any order into a desired target gear G1-G16 is triggered by correspondingly activating the particular cam element 2, 3, 4, 5, enabling, for example, gear shifts from the fifteenth gear step G15 into the fifth gear step G5, or the like.

With the bottom bracket gearbox according to the invention, it is possible, for example, for a user to individually establish the number of gears. The user has the option, in particular with a gearbox having a high number of gears and uniform stepping, to intentionally omit some of the gears in order to be able to implement large or small ratio steps using the same basic gearbox.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 bicycle
2 first cam element
3 second cam element
4 third cam element
5 fourth cam element
6 first brake pawl
7 second brake pawl
8 third brake pawl
9 fourth brake pawl
10 housing or bottom bracket housing
11 locking toothing
12 curved path of the first cam element
13 curved path of the second cam element
14 curved path of the third cam element
15 curved path of the fourth cam element
16 rotary drive
17 reduction gear
18 central axis of rotation of the bottom bracket gearbox
RS1 planetary gear set
RS2 planetary gear set
RS3 planetary gear set
RS4 planetary gear set
G1-G16 gear steps
B1 first brake shift element
B2 second brake shift element
B3 third brake shift element
B4 fourth brake shift element
F1 first freewheel clutch
F2 second freewheel clutch
F3 third freewheel clutch
F4 fourth freewheel clutch

1-11. (canceled)

12. A bottom bracket gearbox for a bicycle (1), the bottom bracket gearbox having a planetary gear set design, the bottom bracket gearbox comprising:
at least one brake shift element (B1, B2, B3, B4);
at least one brake pawl (6, 7, 8, 9) actuatable for blocking and releasing an associated gearbox component for shifting a gear step (G1-G16); and
an arrangement for actuating the at least one brake pawl (6, 7, 8, 9), the arrangement comprising at least one cam element (2, 3, 4, 5), each of the at least one cam element (2, 3, 4, 5) being operatively connected to a respective one of the at least one brake pawl (6, 7, 8, 9) and being separately activatable.

13. The bottom bracket gearbox of claim 12, wherein one or more of the at least one brake pawl (6, 7, 8, 9) is a spring-loaded rocker, a first rocker arm of the spring-loaded rocker being associated with a locking toothing (11) of the associated gearbox component, and a second rocker arm of the spring-loaded rocker being associated with a curved path (12, 13, 14, 15) provided on a periphery of the at least one cam element (2, 3, 4, 5) for actuating the one or more of the at least one brake pawl (6, 7, 8, 9).

14. The bottom bracket gearbox of claim 13, further comprising a rotatable roller on the second rocker arm as a contact surface with the curved path (12, 13, 14, 15).

15. The bottom bracket gearbox of claim 12, wherein a swivel axis of each of the at least one brake pawl (6, 7, 8, 9) and an axis of rotation of each of the at least one cam element (2, 3, 4, 5) is approximately axially parallel to a central axis of rotation of the bottom bracket gearbox (18).

16. The bottom bracket gearbox of claim 12, further comprising at least one rotary drive (16), each of the at least one rotary drive (16) being associated with a corresponding one of the at least one cam element (2, 3, 4, 5) for separate activation.

17. The bottom bracket gearbox of claim 16, wherein rotational motion of each of the at least one rotary drive (16) is transmittable onto the corresponding one of the at least one cam element (2, 3, 4, 5) via a respective reduction gear (17).

18. The bottom bracket gearbox of claim 17, wherein the respective reduction gear (17) comprises multiple planetary gear sets coupled together.

19. The bottom bracket gearbox of claim 12, wherein a curved path (12, 13, 14, 15) provided along a periphery of each of the at least one cam element (2, 3, 4, 5) comprises a shorter ramp portion and a longer ramp portion, the shorter ramp portion having a greater slope than the longer ramp portion, the shorter ramp portion quickly engaging the respective one of the at least one brake pawl (6, 7, 8, 9) with locking toothing of the associated gearbox component, the longer ramp portion disengaging the respective one of the at least one brake pawl (6, 7, 8, 9) from the locking toothing of the associated gearbox component.

20. The bottom bracket gearbox of claim 12, further comprising a position detection sensor associated with the at least one cam element (2, 3, 4, 5).

21. The bottom bracket gearbox of claim 12, wherein the at least one brake shift element (B1, B2, B3, B4) comprises a first brake shift element (B1), a second brake shift element (B2), a third brake shift element (B3), and a fourth brake shift element (B4),
wherein the at least one brake pawl (6, 7, 8, 9) comprises a first brake pawl (6) of the first brake shift element (B1), a second brake pawl (7) of the second brake shift element (B2), a third brake pawl (8) of the third brake shift element (B3), and a fourth brake pawl (9) of the fourth brake shift element (B4), and
wherein the at least one cam element (2, 3, 4, 5) comprises a first cam element (2) associated with the first brake pawl (6), a second cam element (3) associated with the second brake pawl (7), a third cam element (4) associated with the third brake pawl (8), and a fourth cam element (5) associated with the fourth brake pawl (9).

22. A bicycle (1), comprising the bottom bracket gearbox of claim 12.
